(19) United States
(12) Patent Application Publication
(10) Pub. No.: US 2026/0064507 A1
(43) Pub. Date: Mar. 5, 2026

(54) CLOUD MISCONFIGURATION DETECTION BASED ON SELECTIVE CLOUD EVENT MONITORING

(71) Applicant: Palo Alto Networks, Inc., Santa Clara, CA (US)

(72) Inventors: Ignacio Nicolas Bermudez Corrales, Oakland, CA (US); Alok Tongaonkar, San Jose, CA (US); Gaspar Modelo-Howard, Fremont, CA (US)

(21) Appl. No.: 18/823,483

(22) Filed: Sep. 3, 2024

(51) Int. Cl. G06F 11/07; G06F 9/50

(52) U.S. Cl. CPC G06F 11/0712; G06F 9/5072; G06F 9/5077; G06F 2201/80; G06F 2201/84; G06F 2209/501; G06F 2209/508

(57) ABSTRACT

A service determines an initial state of a cloud environment that indicates resources provisioned in the cloud environment. The service subscribes to an event stream over which events occurring in the cloud environment that correspond to cloud API invocations are streamed. The service evaluates data of obtained events to determine if the events are relevant to misconfiguration detection. For those of the events that are relevant to misconfiguration detection, the service updates the state of the cloud environment to reflect the event, such as by creating, updating, or deleting data of cloud resources reflected in the cloud environment state. Periodically, the service evaluates the updated state of the cloud environment based on misconfiguration detection criteria to determine if the updated state is indicative of a misconfiguration(s) in the cloud environment. If one or more of the detection criteria are satisfied, the misconfiguration detector indicates the corresponding misconfiguration.

### BACKGROUND

The disclosure generally relates to data processing (e.g., CPC subclass G06F) and to cloud security (e.g., CPC subclass G06F 21/00).

Cloud service providers/platforms (CSPs) provide cloud computing technology that delivers computing resources in the cloud. With cloud computing, applications and other computing resources traditionally hosted on-premises are delivered by a CSP over the Internet. A variety of vendors of hardware technology and software technology employ the services of CSPs for hosting technology in the cloud instead of or in addition to traditional, on-premises hardware and software delivery. End users of a CSP, including such vendors of cloud-delivered technology, can interact with the CSP via application programming interfaces (APIs) of the CSP. Cloud APIs provide an interface for managing computing resources or utilizing the services of a CSP.

Cloud security posture management (CSPM) refers to management of security risks of cloud infrastructure, with cloud infrastructure encompassing the software and hardware resources of a CSP. For a customer of a CSP, CSPM refers to management of the security risks to customer cloud assets (i.e., application(s), workload, and/or data). While the CSP is responsible for CSPM of the infrastructure provided by the CSP, the CSPM of customer assets involves monitoring assets for risks and compliance auditing based on policy definitions, scanning to ensure policy compliance, and remediation of detected risks. Scanning or searching for risks, such as misconfigurations, can be across cloud environments/infrastructure of different delivery models, including Infrastructure as a Service (IaaS), Platform as a Service (PaaS), and Software as a Service (Saas).

Dangling domains refer to domains or subdomains that point to once-active resources that no longer exist (e.g., due to their deletion). Dangling domains pose a security risk in that they can be exploited via subdomain takeovers. In a subdomain takeover, an attacker re-creates the no longer existing resource, typically using malicious content, and gains control over the subdomain. This allows the attacker to exploit the subdomain for malicious purposes, such as phishing or malware distribution.

### BRIEF DESCRIPTION OF THE DRAWINGS

Embodiments of the disclosure may be better understood by referencing the accompanying drawings.

FIG. 1 is a conceptual diagram of determining state of a cloud environment based on monitoring events occurring therein that are pertinent to cloud misconfiguration detection.

FIG. 2 is a conceptual diagram of detecting cloud misconfigurations based on monitored state of a cloud environment.

FIG. 3 is a flowchart of example operations for monitoring a state of a cloud environment based on streaming events occurring in the cloud environment.

FIG. 4 is a flowchart of example operations for evaluating a monitored state of a cloud environment for misconfiguration detection.

FIG. 5 depicts an example computer system with a cloud state constructor and a cloud misconfiguration detector.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

This description uses shorthand terms related to cloud technology for efficiency and ease of explanation. When referring to “a cloud,” this description is referring to the resources of a CSP (also referred to as a “cloud provider” herein). For instance, a cloud can encompass the servers, virtual machines, and storage devices of a CSP. A cloud resource accessible to customers is a resource owned/managed by the CSP entity that is accessible via network connections. Often, the access is in accordance with an API or software development kit provided by CSP.

This description uses the term “stream” to refer to a unidirectional stream of data flowing over a data connection between two entities in a session. The entities in the session may be interfaces, services, etc. The elements of the stream will vary in size and formatting depending upon the entities communicating with the session. Although the stream elements will be segmented/divided according to the protocol supporting the session, the entities may be handling the data at an operating system perspective, and the stream elements may be data blocks from that operating system perspective. The stream is a “stream” because a data set (e.g., a volume or directory) is serialized at the source for streaming to a destination. Serialization of the stream elements allows for reconstruction of the data set. The data connection over which the data stream flows is a logical construct that represents the endpoints that define the data connection. A session is an abstraction of one or more connections. A session may be, for example, a data connection and a management connection. A management connection is a connection that carries management messages for changing state of services associated with the session.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Detecting misconfigurations in a cloud environment as part of CSPM can be performed by periodically (e.g., every several hours) determining a state of the cloud environment via snapshotting or otherwise querying APIs of services of a CSP that are used in the cloud environment. The “state” of a cloud environment refers to the cloud resources provisioned in the cloud environment and their metadata/data. However, determining cloud environment state in this manner is time consuming due to the wealth of cloud APIs offered by modern CSPs and potentially vast numbers of cloud resources in the cloud environment, thus creating a blind spot for detecting misconfigurations of cloud resources during the state determination period. Disclosed herein are techniques for detecting cloud misconfigurations that substantially reduce this blind spot period by combining event streaming with cloud state snapshotting/querying CSP services to determine state of a cloud environment for misconfiguration detection.

The disclosed service determines an initial state of the cloud environment. The initial state indicates resources in the cloud environment, which can include resources corresponding to different services of the CSP. After the initial state is determined, the service updates the initial state based on select events streamed from the cloud environment over an event stream to which the service subscribes. The service determines which of the events should be reflected in the cloud state through updates to the initial state based on criteria indicating event types that are pertinent to misconfiguration detection. An event type is pertinent to misconfiguration detection if it can contribute to or be informative for detection of a misconfiguration of a cloud resource(s), such as resource creation events, deletion events, or update events for certain resource types or certain cloud services. The service periodically evaluates the updated state of the cloud environment based on misconfiguration detection criteria to determine if the updated state is indicative of a misconfiguration(s) in the cloud environment. The updated state that the service evaluates based on the misconfiguration detection criteria indicates changes to the initial state corresponding to the events determined to be relevant to misconfiguration detection. If one or more of the detection criteria are satisfied, the service indicates the corresponding misconfiguration. Misconfigurations can thus be detected at a more frequent cadence than allowed for by pure snapshotting/cloud API polling techniques, and misconfigurations are not lost to the substantial blind spot associated therewith.

### Example Illustrations

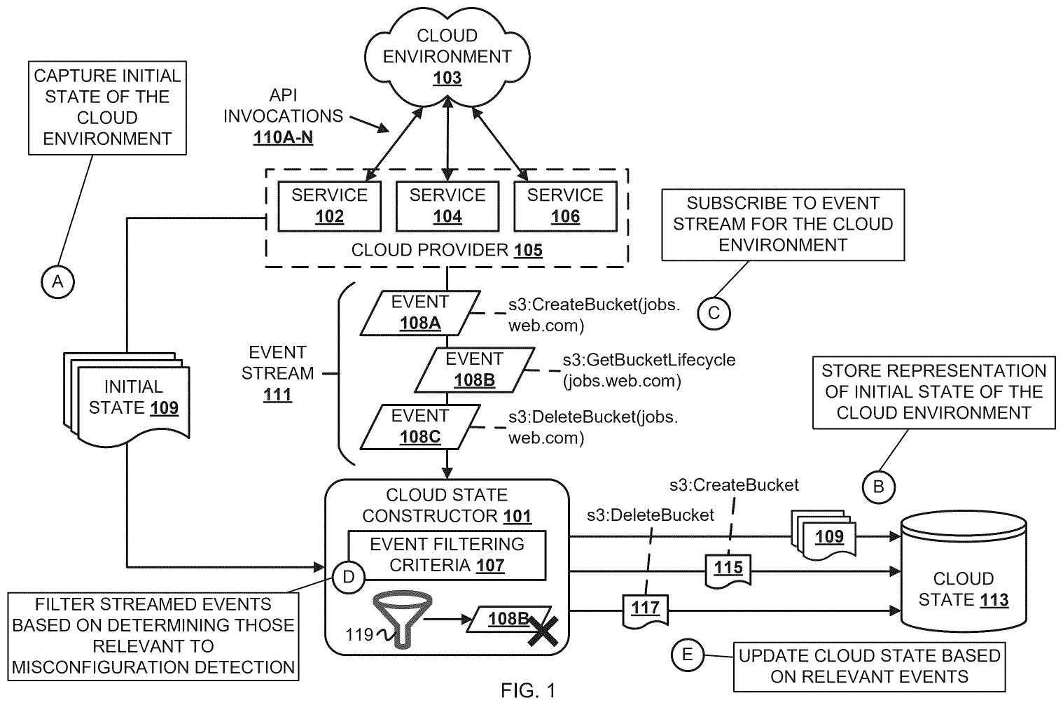

FIG. 1 is a conceptual diagram of determining state of a cloud environment based on monitoring events occurring therein that are pertinent to cloud misconfiguration detection. A cloud environment 103 is managed by a cloud provider 105. The cloud environment 103 can be a public cloud, private cloud, a hybrid cloud, etc. The cloud provider 105 offers various services: a service 102, a service 104, and a service 106.

Examples of services include storage services, database services, and Domain Name System services, among others. While not depicted in FIG. 1 for simplicity, each of the services 102, 104, 106 exposes a respective API by which functionality of each service can be leveraged for the cloud environment 103 via API invocations 110A-N. For instance, customers can invoke functionality of the services 102, 104, 106 via their respective APIs to create resources in the cloud environment 103, store or update resources or data stored in resources in the cloud environment 103, run analytics on the cloud environment 103, etc.

A cloud state constructor 101 constructs a state of the cloud environment 103 based on selective monitoring and tracking of events occurring in the cloud environment 103. The cloud state constructor 101 is referred to as constructing the state since the constructor 101 determines an initial state of the cloud environment 103 (e.g., during first load of the cloud state constructor 101) and updates this initial state as events affecting the cloud state are detected subsequent to determining the initial state. In the context of the cloud environment 103, an event corresponds to an invocation of an API of one of the services 102, 104, 106 that can be captured and reported, documented, etc. Examples of events include creation, deletion, and updating of resources in the cloud environment 103 by invoking APIs of the services 102, 104, 106.

FIG. 1 is annotated with a series of letters A-E. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the cloud state constructor 101 captures an initial state 109 of the cloud environment 103. The initial state 109 at least indicates the resources provisioned in the cloud environment 103 across the services 102, 104, 106 and their configuration (e.g., resource attribute values). Techniques for capturing the initial state may vary across cloud providers. For instance, the cloud state constructor 101 can poll or query the services 102, 104, 106 of the cloud provider 105 to determine the initial state 109 for resources corresponding to the services 102, 104, 106 (e.g., via API polling). As another example, the cloud state constructor 101 can capture a snapshot of the cloud environment 103 or snapshots of the cloud environment 103 corresponding to each of the services 102, 104, 106 (e.g., via an API of each of the services 102, 104, 106 or another API of the cloud environment 103). Cloud providers may perform cloud service polling as part of snapshot generation. The initial state 109 can capture state of the cloud environment 103 corresponding to each of the services 102, 104, 106; in other words, the initial state 109 can comprise initial states for the service 102, the service 104, and the service 106. Data indicating state of the cloud environment 103 includes data of resources provisioned in the cloud environment 103 across services of the cloud provider 105 (i.e., by the services 102, 104, 106). The cloud state constructor 101 captures this initial state 109 of the cloud environment 103 once to obtain a comprehensive view of the resources provisioned in the cloud environment 103 and their configurations.

At stage B, the cloud state constructor 101 stores a representation of the initial state of the cloud environment 103. The cloud state constructor 101 has access to (e.g., maintains or can communicate with) a cloud state database (“database”) 113 that stores data indicating state of the cloud environment 103. The database 113 is depicted as a single database for simplicity, though implementations can maintain a plurality of databases or data structures that correspond to a respective plurality of cloud services (e.g., a database or data structure for each of the services 102, 104, 106). The cloud state constructor 101 inserts the initial state 109 into the database 113 such that each entry in the database 113 corresponds to a resource captured in the initial state 109 and its configuration. Subsequent tracking of resources provisioned in the cloud environment and their configurations will be reflected through ongoing updates to data stored in the database 113 as described below rather than by capturing additional snapshots of the cloud environment 103 or through additional polling of services/APIs of the cloud provider 105 as described at stage A.

At stage C, the cloud state constructor 101 subscribes to an event stream 111 for the cloud environment 103. The cloud provider 105 offers event streaming functionality such that events occurring in the cloud environment 103 are captured and their data/metadata are published to a stream of event data/metadata (hereinafter simply “events”). Events occurring in the cloud environment 103 include the API invocations 110A-N of the APIs of the services 102, 104, 106, such as API functions invoked to create, update, and delete resources in the cloud environment 103. Event streaming can be performed across services of the cloud provider 105 or can be configured for select services. In the latter case, the cloud state constructor 101 subscribes to the event stream 111 for those select services with which it has been configured. To subscribe to the event stream 111, the cloud state constructor 101 can communicate with an event streaming service of the cloud provider 105. In implementations, configuration of the event stream 111 may instead be handled by an end user (e.g., a customer or cybersecurity provider) that has an account with the cloud provider 105. In either case, events captured for the cloud environment 103 are subsequently streamed over the event stream 111 to the cloud state constructor 101.

At stage D, the cloud state constructor 101 filters streamed events based on determining those that are relevant to misconfiguration detection. The cloud state constructor 101 has been configured with an event filter 119 and event filtering criteria (“criteria”) 107. The criteria 107 indicate criteria for determining if an event is relevant to misconfiguration detection, such as event types as represented by API function names. Events are relevant to misconfiguration detection if they may be informative to detecting misconfigurations of a resource, such as creation or deletion of certain resource types. The cloud state constructor 101 filters (e.g., discards or ignores) events that are not relevant to misconfiguration detection since cloud environments often are associated with a plethora of events, and some of these may not be “of interest” for misconfiguration detection; storing all events regardless of whether they may actually be informative for misconfiguration detection thus incurs unnecessary cost. The event filter 119 evaluates events incoming over the event stream 111 based on the criteria 107 to determine whether the cloud state should be updated to reflect those events or if the events can be filtered out from cloud state monitoring.

In this example, the cloud provider 105 streams three events over the event stream: an event 108A, an event 108B, and an event 108C. The events 108A-C correspond to API invocations of the Amazon Web Services® (AWS) storage service, S3. In particular, the event 108A is a CreateBucket event for a bucket associated with a domain name “jobs.web.com”, the event 108B is a GetBucketLifecycle event for the bucket with the domain name “jobs.web.com”, and the event 108C is a DeleteBucket event for a bucket with the domain “jobs.web.com”. These events can be streamed over the event stream 111 at differing times and are depicted as incoming over the event stream 111 together in FIG. 1 for ease of illustration. The cloud state constructor 101 receives the events 108A-C on the event stream 111, and the event filter 119 evaluates the events 108A-C based on the criteria 107. This example assumes that the events 108A, 108C are determined to be relevant to misconfiguration detection based on the evaluation against the criteria 107, while the event 108B is not relevant to misconfiguration detection. To illustrate, events for creating and deleting storage units such as buckets may be informative for misconfiguration detection (particularly for detection of dangling domains), while events for simply reading information for a storage unit or other resource such as the event 108B is not informative to misconfiguration detection. The cloud state constructor 101 thus filters the event 108B to remove the event 108B from further cloud state updating operations.

At stage E, the cloud state constructor 101 updates the cloud state as represented in the database 113 based on the relevant events. Generally, the cloud state constructor 101 can update the database 113 to insert entries storing data of resources associated with resource creation events, update entries of resources associated with resource update events, and/or delete entries of resources associated with resource deletion events. Since the cloud state constructor 101 determined the events 108A, 108C to be relevant to misconfiguration detection, the cloud state constructor 101 updates the database 113 to reflect the corresponding events. In particular, the cloud state constructor 101 submits a query 115 to the database 113 that indicates the event 108A, which should create an entry in the database 113 for the bucket with the domain name “jobs.web.com”. The cloud state constructor 101 later submits a query 117 to the database 113 that indicates the event 108C, which should delete the entry in the database for the aforementioned bucket. Updating the cloud state represented in the database 113 based on event streaming and selective updating after capturing the initial state 109 incurs lower overhead than repeated snapshotting/service polling for state determination and is less time consuming than capturing state with these techniques exclusively.

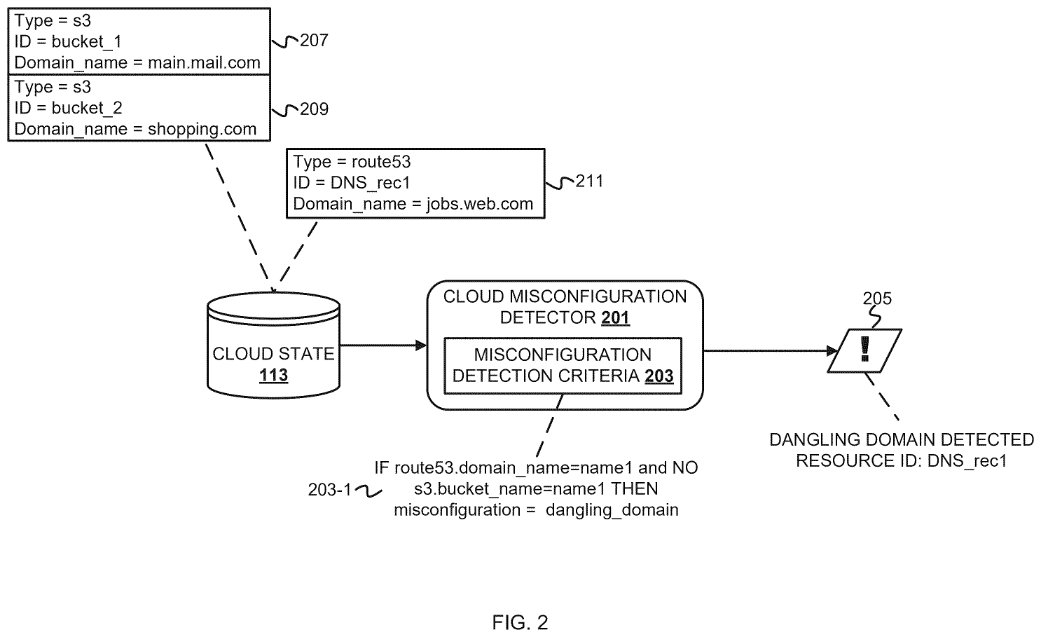

FIG. 2 is a conceptual diagram of detecting cloud misconfigurations based on monitored state of a cloud environment. Evaluating the cloud state for misconfigurations can occur periodically, such as according to a schedule or at fixed time increments (e.g., every 15 minutes). FIG. 2 depicts data/metadata of example resources maintained in the database 113 that correspond to the cloud environment 103 of FIG. 1: a resource 207 and a resource 209, which correspond to storage buckets created with the AWS S3 service, and a resource 211, which corresponds to DNS records created with the AWS Route 53 service. The data/metadata of the resources 207, 209, 211 are assumed to have been stored in the database 113 by the cloud state constructor 101 described in reference to FIG. 1. The resources 207, 209 correspond to buckets associated with respective domain names “main.mail.com” and “shopping.com”. The resource 211 corresponds to a DNS record for a respective domain name “jobs.web.com”.

Once cloud state evaluation for misconfiguration detection has been triggered, a cloud misconfiguration detector (“detector”) 201 evaluates cloud resource data maintained in the database 113 based on misconfiguration detection criteria (“criteria”) 203. The detector 201 can be invoked upon detection of the trigger (e.g., by the cloud state constructor 101 of FIG. 1) or can monitor for the triggering condition to initiate misconfiguration detection. Misconfigurations for which the detector 201 evaluates the cloud state maintained in the database 113 based on the criteria 203 include misconfigurations of cloud resources (either individual cloud resources or in groups of cloud resources), including errors in configuration that increase security risks. This example depicts an example one of the criteria 203, a criterion 203-1, as indicating that if an AWS Route 53 resource with a domain name “name1” exists that points to a non-existent AWS S3 bucket “name1”, a dangling domain misconfiguration should be detected.

When evaluating the resource data maintained in the database 113, the detector 201 identifies the resource 211 with the domain name “jobs.web.com” and determines that the S3 bucket pointed to by the domain name “jobs.web.com” does not exist, as neither of the resources 207, 209 have been configured with this domain name. The detector 201 determines that the criterion 203-1 is thus satisfied and detects a dangling domain misconfiguration for the cloud environment 103. The detector 201 generates an alert 205 indicating that a dangling domain was detected for the cloud environment 103. The alert 205 identifies the resource 211 associated with the dangling domain. The dangling domain misconfiguration can thus be remediated more rapidly than would be allowed for with exclusively snapshotting/API-polling-based misconfiguration detection approaches.

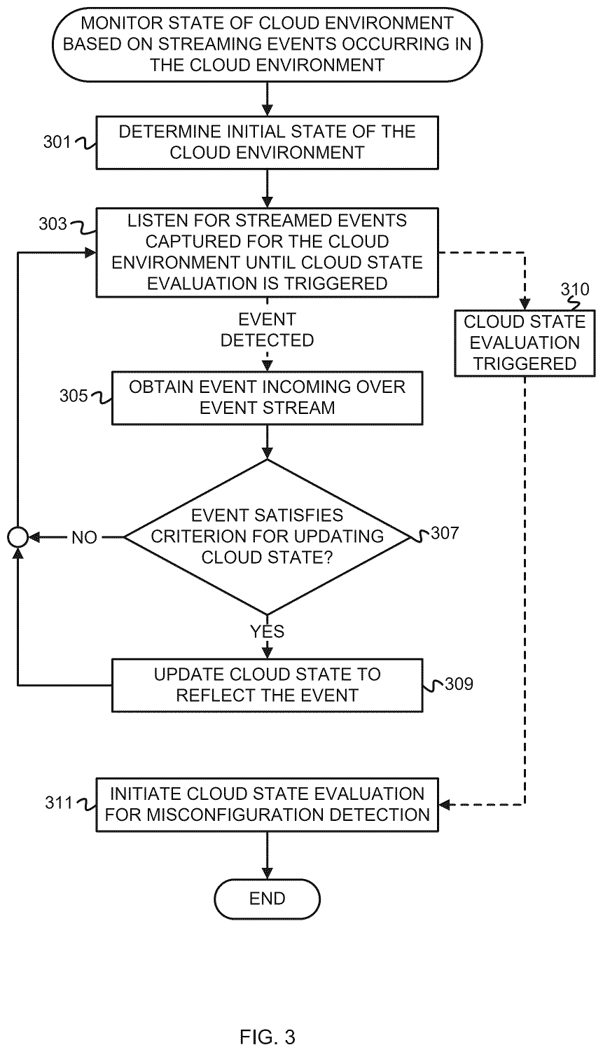

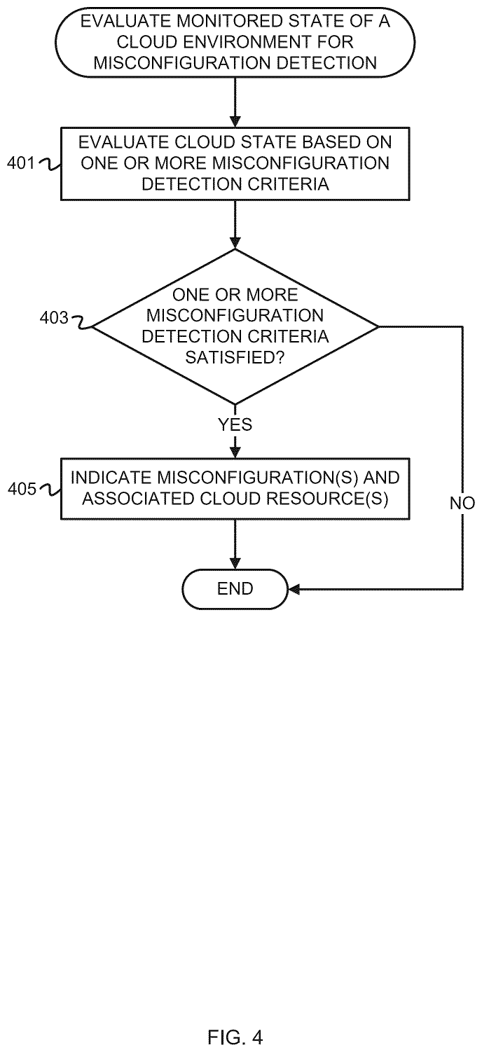

FIGS. 3-4 are flowcharts of example operations. The example operations are described with reference to a cloud state constructor and a cloud misconfiguration detector (hereinafter “the state constructor” and “the misconfiguration detector,” respectively) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for monitoring a state of a cloud environment based on streaming events occurring in the cloud environment. As described above, state of a cloud environment refers to the resources provisioned in the cloud environment and their configurations. The example operations are described as being performed by the state constructor.

At block 301, the state constructor determines an initial state of the cloud environment. The initial state is a comprehensive view of resources provisioned in the cloud environment across cloud services and their configurations. Determination of the initial state can be dependent on the cloud provider and the functionality offered by the cloud provider. In some examples, the state constructor determines the initial state by creating a snapshot of the cloud environment or polling services of the cloud provider that are used for the cloud environment for provisioned resources in the cloud environment. The state constructor stores the data/metadata of the initial state in a database(s) or data structure(s). Cloud state can be stored in a plurality of databases or data structures, where each database/data structure comprises data/metadata of resources corresponding to a respective service of the cloud provider. In other words, cloud state data/metadata corresponding to different cloud services can be stored in different respective data stores.

At block 303, the state constructor listens for events captured for the cloud environment streamed over an event stream to which the state constructor subscribes until cloud state evaluation is triggered. The state constructor is subscribed to an event stream to which the cloud provider publishes data/metadata of events (hereinafter simply “events”). Events published to the event stream correspond to API invocations for various services of the cloud environment. The state constructor may subscribe to event streaming across services of the cloud provider that are compatible with streaming functionality or for select services (i.e., a subset of the services). Whether the state constructor subscribes to event streaming across services or for select services may be dependent on the streaming functionality offered by the cloud provider.

Block 303 continues at either block 305 or block 310. Block 303 continues at block 305 when an event is detected over the event stream. Block 303 continues at block 310 when cloud state evaluation is triggered. Additionally, while depicted as occurring sequentially in FIG. 3 for a single event, processing of event data obtained over the event stream can be handled asynchronously when data of multiple events are received. Alternatively, or in addition, event data received over the event stream may be placed in a queue for processing by the state constructor. Block 303 is depicted as connected to each of block 305 and block 310 with a dashed line to indicate that flow to either operation can be dependent on an event being detected (as is the case for block 305) or on a triggering condition occurring or being satisfied (as is the case for block 310).

At block 305, the state constructor obtains an event incoming over the event stream. The event at least indicates a service of the cloud provider to which the event corresponds and an API function call associated with the event. The event can also indicate a resource (e.g., a resource created, updated, or deleted via the API function call) and attributes of the resource, such as a resource identifier and/or other data/metadata of the resource.

At block 307, the state constructor determines if the event satisfies a criterion for updating the cloud state. The state constructor has been configured with one or more criteria for determining whether streamed events are relevant to misconfiguration detection and thus should be represented in the cloud state with an update to the initial cloud state. The criteria can indicate one or more services of the cloud provider, types of events (i.e., API functions), and/or event attributes (e.g., values of event data/metadata fields). The criteria often indicate API functions that correspond to create, update, and delete events for designated types of cloud resources that can be impacted by a misconfiguration. If the event satisfies a state update criterion, operations continue at block 309. Otherwise, operations continue at block 303, where the state constructor continues to await events incoming over the event stream.

At block 309, the state constructor updates the cloud state to reflect the event. The state constructor inserts the event into the database or data structure in which the initial state of the cloud environment is maintained. Inserting the event can result in creating a new entry corresponding to a resource, updating an entry corresponding to a resource, or deleting an entry corresponding to a resource. Operations continue at block 303.

At block 310, cloud state evaluation is triggered. Cloud state evaluation can be triggered based on a period of time since a prior evaluation being performed (e.g., 15 minutes between evaluations) or can be triggered based on a schedule for cloud state evaluation. As another example, cloud state evaluation can be triggered by detection of certain event types (e.g., deletion events) or after a designated number of events have been detected (e.g., every 10 events).

At block 311, the state constructor initiates cloud state evaluation for misconfiguration detection. The updated state of the cloud environment, which reflects changes to the initial state corresponding to events relevant to misconfiguration detection that were detected since the initial state was captured, is evaluated for misconfiguration detection. Cloud state evaluation is described in further detail in reference to FIG. 4.

While operations are depicted as being complete after block 311, the state constructor can continue to listen for events published to the event stream during cloud state evaluation so that events of interest are not missed during the evaluation. Updates to the cloud state that are to be made based on events detected during the evaluation period can be queued for insertion into the database/data structure upon completion of evaluation operations.

FIG. 4 is a flowchart of example operations for evaluating a monitored state of a cloud environment for misconfiguration detection. Evaluation of the cloud state for misconfigurations can be performed periodically (e.g., every 15 minutes, hourly, etc.). The example operations assume that misconfiguration detection has been triggered, such as based on a designated amount of time elapsing since a preceding evaluation or according to a scheduled evaluation event. The example operations are described as being performed by the misconfiguration detector.

At block 401, the misconfiguration detector evaluates the cloud state based on one or more misconfiguration detection criteria. Each of the misconfiguration detection criteria can indicate one or more attribute values of resources reflected in the cloud state (i.e., having data/metadata stored in the database(s) or other data store(s) maintaining the cloud state) that should be checked. An example criterion is a criterion for detecting dangling domains in the cloud environment if the cloud state includes a DNS record with a domain name that does not have a corresponding storage resource configured for that domain name in the cloud environment. For evaluating the cloud state based on this criterion, the misconfiguration detector checks domain name values associated with DNS record resources and storage resources (e.g., storage buckets) represented in the cloud state to determine if each DNS record resource has a corresponding storage resource. Evaluation of the cloud state can be performed across databases or data structures if the cloud state data/metadata were stored in multiple databases/data structures (e.g., based on correspondence of the cloud state data/metadata to different cloud services).

At block 403, the misconfiguration detector determines if one or more misconfiguration detection criteria are satisfied. The misconfiguration detector determines if any of the criteria are satisfied as a result of the evaluation. If a misconfiguration detection criterion(a) is satisfied, operations continue at block 405. If no criteria are satisfied, operations are complete.

At block 405, the misconfiguration detector indicates the misconfiguration(s) and the associated cloud resource(s). The misconfiguration detector can generate a notification, report, or alert that indicates each detected misconfiguration and the affected resource(s), can present the notification, report or alert on a display (e.g., a graphical user interface (GUI)) and/or store the notification, report, or alert in a database, etc. For the dangling domain misconfiguration, the misconfiguration detector can indicate that a dangling domain was detected for the cloud environment and identify the DNS record resource that is absent a corresponding storage resource. The cloud resource(s) can thus be prioritized for remediation or corrective action.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted from blocks 305 to 309 of FIG. 3 can be performed at least partially in parallel or concurrently as event data are obtained over the event stream. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

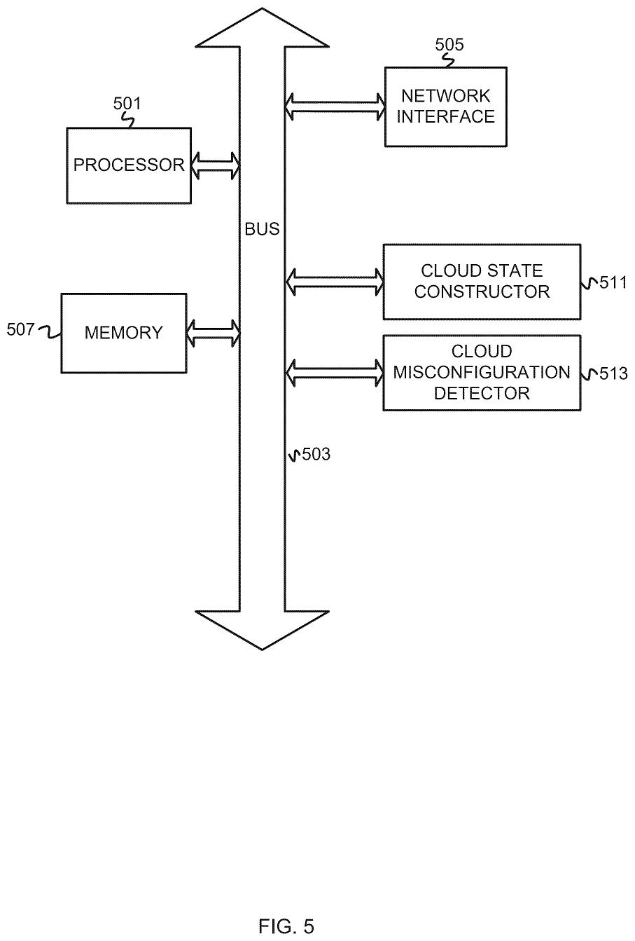

FIG. 5 depicts an example computer system with a cloud state constructor and a cloud misconfiguration detector. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes cloud state constructor 511 and cloud misconfiguration detector 513. The cloud state constructor 511 constructs a representation of the state of a cloud environment based partly on selectively monitoring and recording events occurring in the cloud environment that affect resources in the cloud environment. The events are streamed to the cloud state constructor 511 from the cloud environment as APIs of the cloud provider are invoked to perform various functionality in the cloud environment. The cloud state constructor 511 identifies the events that have been determined to be relevant to misconfiguration detection and updates the representation of the cloud state to reflect those events that are relevant. The cloud misconfiguration detector 513 periodically evaluates the cloud state constructed by the cloud state constructor 511 to detect any misconfigurations, such as those that pose security risks. While depicted as part of the same computer system in FIG. 5 for clarity, the cloud state constructor 511 and the cloud misconfiguration detector 513 do not necessarily execute as part of the same computer system in implementations. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
determining a first state of a cloud environment, wherein the cloud environment is associated with a cloud service provider (CSP);
constructing an updated state of the cloud environment based on streaming events occurring in the cloud environment following determination of the first state of the cloud environment,
wherein constructing the updated state of the cloud environment comprises updating the first state of the cloud environment based on at least a subset of the events streamed from the cloud environment,
wherein the events correspond to invocations of one or more application programming interfaces (APIs) of the CSP;
evaluating the updated state of the cloud environment based on a misconfiguration detection criterion; and
based on determining that the updated state of the cloud environment satisfies the misconfiguration detection criterion, indicating that the cloud environment comprises a misconfiguration.

2. The method of claim 1, wherein determining the first state of the cloud environment comprises at least one of taking a snapshot of the cloud environment and querying one or more services of the CSP for states of cloud resources of the cloud environment, wherein the one or more APIs of the CSP correspond to the one or more services of the CSP.

3. The method of claim 1, further comprising filtering the events streamed from the cloud environment based on one or more criteria to obtain the subset of the events, wherein the one or more criteria indicate a respective one or more types of events that are relevant to cloud environment misconfigurations, and wherein the subset of the events comprise those of the events that are relevant to cloud environment misconfigurations.

4. The method of claim 1, wherein the misconfiguration detection criterion comprises a criterion for detecting dangling domain misconfigurations, wherein evaluating the updated state of the cloud environment based on the misconfiguration detection criterion comprises determining if the cloud environment comprises a domain name resource that does not have a corresponding storage resource of a storage service of the CSP.

5. The method of claim 4, wherein determining that the updated state of the cloud environment satisfies the misconfiguration detection criterion comprises determining based on the updated state that the cloud environment comprises a domain name resource that does not have a corresponding storage resource in the cloud environment, wherein indicating that the cloud environment comprises a misconfiguration comprises indicating that the cloud environment comprises a dangling domain misconfiguration.

6. The method of claim 1, wherein the first state of the cloud environment indicates a plurality of resources associated with the cloud environment, and wherein the updated state of the cloud environment indicates detected changes to at least a subset of the plurality of resources.

7. The method of claim 1, wherein constructing of the updated state of the cloud environment is ongoing, and wherein evaluating the updated state of the cloud environment based on the misconfiguration detection criterion is performed periodically.

8. One or more non-transitory machine-readable media having program code stored thereon, the program code comprising instructions to:
determine an initial state of a cloud environment offered by a cloud provider;
determine an updated state of the cloud environment based on streamed events occurring in the cloud environment that correspond to invocations of one or more application programming interfaces (APIs) of the cloud provider, wherein the instructions to determine the updated state of the cloud environment comprise instructions to update the initial state of the cloud environment based on at least a subset of the streamed events;
evaluate the updated state of the cloud environment based on one or more criteria for detecting misconfigurations; and
based on a determination that the updated state of the cloud environment satisfies a first of the one or more criteria, indicate that the cloud environment comprises a misconfiguration.

9. The non-transitory machine-readable media of claim 8, wherein the instructions to determine the initial state of the cloud environment comprise at least one of instructions to create a snapshot of the cloud environment and instructions to query one or more services of the cloud provider for states of cloud resources of the cloud environment, wherein the one or more APIs of the cloud provider correspond to the one or more services of the cloud provider.

10. The non-transitory machine-readable media of claim 8, wherein the program code further comprises instructions to filter the streamed events based on one or more criteria to obtain the subset of the streamed events, wherein the one or more criteria indicate a respective one or more types of events that are relevant to cloud environment misconfigurations, and wherein the subset of the streamed events comprise those of the events that are relevant to cloud environment misconfigurations.

11. The non-transitory machine-readable media of claim 8, wherein the first criterion comprises a criterion for detecting dangling domain misconfigurations, wherein the instructions to evaluate the updated state of the cloud environment based on the one or more criteria comprise instructions to determine if the cloud environment comprises a domain name record that does not have a corresponding storage resource.

12. The non-transitory machine-readable media of claim 11, wherein the instructions to determine that the updated state of the cloud environment satisfies the first criterion comprise instructions to determine based on the updated state that the cloud environment comprises a domain name record that does not have a corresponding storage resource in the cloud environment, wherein the instructions to indicate that the cloud environment comprises a misconfiguration comprise instructions to indicate that the cloud environment comprises a dangling domain misconfiguration.

13. The non-transitory machine-readable media of claim 8, wherein the initial state of the cloud environment indicates a plurality of resources associated with the cloud environment, and wherein the updated state of the cloud environment indicates detected changes to resources associated with the cloud environment.

14. An apparatus comprising:
a processor; and
a machine-readable medium having instructions stored thereon that are executable by the processor to cause the apparatus to,
determine an initial state of a cloud environment, wherein the cloud environment is associated with a cloud service provider (CSP);
construct an updated state of the cloud environment based on streaming events occurring in the cloud environment following determination of the initial state of the cloud environment and updating the initial state of the cloud environment based on at least a subset of the events streamed from the cloud environment,
wherein the events correspond to invocations of one or more application programming interfaces (APIs) of the CSP;
determine if the cloud environment comprises a misconfiguration based on evaluation of the updated state of the cloud environment against one or more criteria for detecting misconfigurations; and
based on a determination that the updated state of the cloud environment satisfies a first of the criteria, indicate that the cloud environment comprises a misconfiguration.

15. The apparatus of claim 14, wherein the instructions executable by the processor to cause the apparatus to determine the initial state of the cloud environment comprises at least one of instructions executable by the processor to cause the apparatus to capture a snapshot of the cloud environment and instructions executable by the processor to cause the apparatus to query one or more services of the CSP for states of cloud resources of the cloud environment, wherein the one or more APIs of the CSP correspond to the one or more services of the CSP.

16. The apparatus of claim 14, further comprising instructions executable by the processor to cause the apparatus to filter the events streamed from the cloud environment based on one or more criteria to obtain the subset of the events, wherein the one or more criteria indicate a respective one or more types of events that are relevant to cloud environment misconfigurations, and wherein the subset of the events comprise those of the events that are relevant to cloud environment misconfigurations.

17. The apparatus of claim 14, further comprising instructions executable by the processor to cause the apparatus to evaluate the updated state of the cloud environment against the one or more criteria, wherein the one or more criteria comprise a criterion for detecting dangling domain misconfigurations, wherein the instructions executable by the processor to cause the apparatus to evaluate the updated state of the cloud environment against the one or more criteria comprise instructions executable by the processor to cause the apparatus to determine if the cloud environment comprises a domain name record that does not have a corresponding storage resource.

18. The apparatus of claim 17, wherein the instructions executable by the processor to cause the apparatus to determine that the updated state of the cloud environment satisfies the first criterion comprise instructions executable by the processor to cause the apparatus to determine based on the updated state that the cloud environment comprises a domain name record that does not have a corresponding storage resource in the cloud environment, wherein the instructions executable by the processor to cause the apparatus to indicate that the cloud environment comprises a misconfiguration comprise instructions executable by the processor to cause the apparatus to indicate that the cloud environment comprises a dangling domain misconfiguration.

19. The apparatus of claim 14, wherein the initial state of the cloud environment indicates a plurality of resources associated with the cloud environment, and wherein the updated state of the cloud environment indicates detected changes to resources associated with the cloud environment.

20. The apparatus of claim 14, wherein construction of the updated state of the cloud environment is ongoing, and wherein evaluation of the updated state of the cloud environment against the one or more criteria is performed periodically.
